(19) United States
(12) Patent Application Publication
(10) Pub. No.: US 2004/0201751 A1
(43) Pub. Date: Oct. 14, 2004

(54) Secure digital photography system

(76) Inventors: Genevieve Bell, Portland, OR (US); Timothy L. Brooke, Portland, OR (US); Danah Boyd, Cambridge, MA (US); Bradford H. Needham, North Plains, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/038,365

(22) Filed: Jan. 3, 2002

(51) Int. Cl. H04N 5/76

(52) U.S. Cl. 348/231.99

(57) ABSTRACT

A digital camera includes a memory to store image data of a captured image representing a scene in the physical world, and an encryption module configured to digitally sign the image data prior to storage using a private key of an asymmetric key pair and to obtain metadata associated with the image data. The digital camera is communicatively coupled to a digital photography subsystem. The host-based subsystem includes a decryption module to accept image data and metadata from the digital camera and to verify the digital signature of the image data to determine authenticity of the captured image represented by the image data using a public key of the asymmetric key pair, and a viewer module to display the image data when the decryption module indicates the image data is authentic. Metadata used in assisting a determination of authenticity may include at least one of date and time the image was captured by the digital camera, at least one of name and identifier of the camera owner, at least one of name and identifier of the photographer, focal distance, white levels, f-stop, brightness compensation, and distance for auto-focus, when the image was captured.

### BACKGROUND

1. Field

The present invention relates generally to security in computer and consumer electronics systems and, more specifically, to authentication of digital photographs.

2. Description

The use of digital cameras has become widespread. A digital camera captures an image in the physical world and stores that image as digital data in a memory (e.g., a flash memory) within the camera. The memory may be removed from the camera, read by an input/output (I/O) device, and transferred to a computer system. Alternatively, the image data in the camera's memory may be directly read by a computer system over a bus (such as a Universal Serial Bus (USB) for example). Once the image data is stored in a memory in the computer system, the image may be manipulated using well known digital imaging software tools.

Currently, it is difficult to discern if a photograph transferred to a computer system has been manipulated, or if the photograph is a genuine representation of a scene in the physical world. In addition, original realistic looking photographic renderings can be produced on a computer system without any corresponding “real” scene in the physical world, and there is no easy way to determine the difference between a true photograph and computer renderings. These problems are likely to worsen as it becomes easier to create realistic computer renderings and alterations of images. Thus, a system that authenticates digital photographs may be desired where a party seeks some assurance that a digital image actually represents a scene in the physical world.

### BRIEF DESCRIPTION OF THE DRAWINGS

The features and advantages of the present invention will become apparent from the following detailed description of the present invention in which:

FIG. 1 is a diagram of a secure digital photography system according to an embodiment of the present invention; and

FIG. 2 is a diagram illustrating photograph data according to an embodiment of the present invention.

### DETAILED DESCRIPTION

An embodiment of the present invention is a system that provides users of the system with a means for providing some assurance as to the origin of a digital photograph. That is, the system authenticates images captured by a digital camera. By using the present system, one can have more confidence that a digital image presented as being “real” or authentic is indeed genuine. In the present system, the digital camera is trusted, rather than the photographer.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

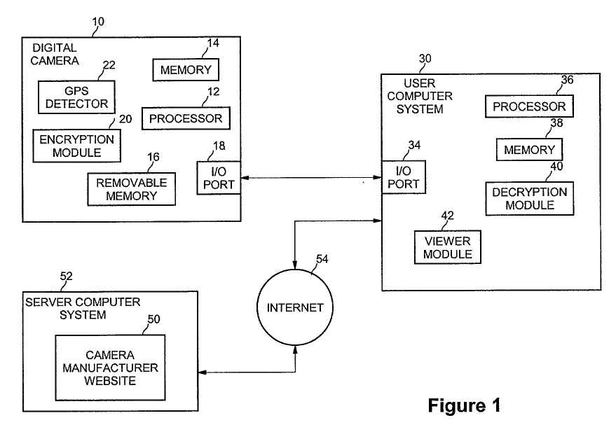

FIG. 1 is a diagram of a secure digital photography system according to an embodiment of the present invention. Digital camera 10 generally comprises many of the components of a conventional digital camera. These components are omitted from FIG. 1 for clarity. Such components include circuitry for capturing an image representing a scene in the physical world, converting the image into digital format, and storing the resulting image data. Digital camera 10 includes a processor 12 for executing programs to operate the camera and control captured images and a memory 14 for storing programs and data. Image data may be stored in well-known ways on removable memory 16 (such as a flash memory, for example). In one embodiment, the image data may be stored in the Exchangeable Image File Format (EXIF), as publicly available on the Internet at (http://www.pima.net/standards/it10/PIMA 15740/exif.htm). An I/O port 18 may be included to allow the digital camera to communicate image data to another device, such as a computer system or printer.

In one embodiment, the digital camera also includes encryption module 20. Encryption module 20 may be used to encrypt image data created by the digital camera using known public key cryptography techniques. The encryption module may be implement in software, firmware, or hardware. In one embodiment, encryption module 20 digitally signs the image data representing a photograph. When the encryption module is implemented in software, the encryption module may be protected from tampering by using known tamper resistant software techniques. In one embodiment, global positioning system (GPS) detector 22 may be included in the digital camera to obtain geographic location information for the camera at the time a photograph is taken, according to known methods of receiving and interpreting GPS signals.

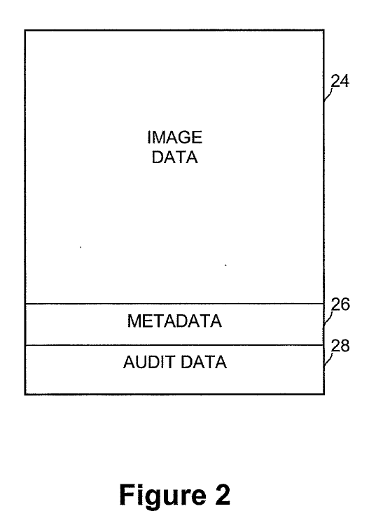

The digital camera of the present system allows a user to take a photograph in a similar way to existing digital cameras. However, in the present system, as the photograph is being written to removable memory 16, the image data representing the photograph may be encoded in a secure manner by encryption module 20. Other information, denoted metadata herein, may also be stored with the image data. Additionally, an optional audit trail (described further below) may also be stored. The combination of image data, metadata, and audit data may be called photograph data. Each photograph data unit may include information representing the captured image, the characteristics of the image and the image capture operation, and any changes to the image after capture. A plurality of photograph data units may be combined into a data structure or file for ease of transmission and/or organization. FIG. 2 is a diagram illustrating photograph data according to an embodiment of the present invention. As shown in FIG. 2, image data 24 may be accompanied by metadata 26 and audit data 28.

Metadata 26 comprises miscellaneous information about the image. Generally, the metadata comprises any information associated with an image used in certifying the origin and authenticity of the image. In one embodiment, the metadata includes one or more of: the date and time the image was captured, the name or identifier of the camera owner, the name or identifier of the photographer (if different than the camera owner), the focal distance, white levels, f-stop, brightness compensation, distance for auto-focus, geographic location of the camera when the image was captured, thermometer reading, barometer reading, compass orientation of the camera, photographer fingerprint data, digital signature of the image data, and digital signature of the image data and the other metadata. These parameters are illustrative examples of metadata and are not meant to limit the scope of the invention in any way. Other camera parameters, scene information, and other information may also be included in the metadata.

Thus, the digital camera of embodiments of the present invention captures the image, obtains the associated metadata along with the image data, encrypts and/or digitally signs the data, and then stores the data in a memory. Since one cannot always trust the photographer, one would like to be able to trust the camera. Hence, by encrypting and/or digitally signing the photographic data, some added level of security may be obtained. In one embodiment, a private key of an asymmetric cryptographic key pair used for encrypting and/or signing the data by encryption module 20 may be written to memory 14 by the manufacturer of the digital camera. This key may be unique for the individual digital camera (that is, all digital cameras have different private keys). The manufacturer then, in essence, acts as a certificate authority (CA) in this security system. In an embodiment, the private key may be stored in a tamper-resistant read-only memory (ROM) (not shown) within the camera. Alternatively, the private key may be “hard-coded” into the circuitry of the camera. In another embodiment, the private key stored in the camera may be associated with the manufacturer and may be the same for all cameras made by that manufacturer, or for all cameras of a certain model. In another embodiment, the key used may be the private key of the camera owner or photographer. In this case, the photographer must download or otherwise set up the private key in the camera prior to secure use.

According to the present invention, the digital camera thus becomes a data acquisition device that vouches for its own data. Through verification of the metadata, the camera can be trusted to communicate an authentic image representing a scene in the physical world.

In order to view a digital photograph taken by the digital camera, the photograph data may be transferred to another device, where it may be handled by a digital photography subsystem. For example, the digital camera may be coupled to a user's computer system 30. The photograph data may be uploaded over a bidirectional communications line 32 via a corresponding I/O port 34 of the computer system (such as a USB, for example). The computer system may be a conventional general purpose computer (such as a personal computer (PC)) having a processor 36 and a memory 38 (as well as other conventional components not shown), or it may be a special purpose electronic device to read, view, and/or print digital photographs.

In one embodiment, software operating on the computer system causes the reading of selected photograph data from the camera. The software may read the digital signature associated with an image (the digital signature being stored in the metadata) and verify the signature using the matching public key. The matching public key may be accessible on the computer system for this purpose. The software may also check other metadata components to add to the authenticity determination (such as date, time, geographic location, f-stop, etc.). If either of these two authentication steps fail, the computer system user may be notified that the image is not authentic. If the authentication steps succeed, then the software may allow viewing or other processing of the authentic image.

Two modules may be included to assist in receiving and processing the digital photograph data. A decryption module 40 may be used to decrypt and/or verify the digital signature of the photograph data. The decryption module may be encoded with the necessary information (such as a matching public key) to decrypt and/or authenticate the data using well-known methods. A viewer module 42 may be used to browse one or more images contained in a photograph data file, authenticate the metadata, authenticate the image(s), and view the image(s). In one embodiment, these two modules may be integral. Because the photograph data is encrypted prior to transfer from the camera, it may be difficult to alter or manipulate the image in transit over the bus or upon reception by a computer system. This provides a basic level of security and authentication.It is likely that digital photographs taken with the digital camera of the present invention would be viewed by many application programs executing on the user's computer system, such as imaging tools and web browsers. A software “plug-in” module could be provided that would allow other applications to view or copy the protected digital photographs to other formats by interoperating with the plug-in. This plug-in could provide the functionality of the decryption and viewer modules describe above. Of course, once the protected digital photograph data is converted to another file format (such as Joint Photographic Experts Group (JPEG) format), the photograph may no longer be authenticated according to the present invention.

Viewer module 42 may also read the metadata 26 associated with image data 24 to provide additional assurance that the digital photograph is an accurate and genuine representation of the scene in the physical world. For example, the metadata may be used to detect the difference between taking a photograph of a photograph of a boat, and taking a photograph of a boat, directly by comparing image metadata with the lighting conditions or focal distance required to take a photograph of the scene. The viewer module uses the metadata from the photograph data file to assist in authenticating the photograph. Many individual data items of the metadata may be used to assist in authenticating an image. In one embodiment, the geographic location of the camera at the time the image was captured, in conjunction with the date and time, may be used to authenticate the image.

Additionally, inspection of the metadata by the user of the viewer module may add further authentication than may be possible by automated means. For example, if the metadata for a photograph contains GPS coordinates of 45.524° N 122.675° W (Portland, Oregon), but the caption or other information related to the digital photograph claims that the captured image is of Mount Rushmore (which is at 43.880° N 103.458° W), a person with a map display of the photo GPS coordinates may recognize that the digital photograph wasn't taken anywhere near Mount Rushmore. Similarly, if the scene captured in the image is a sunny one and the capture time indicates 11 pm local time, or if the image is obviously a flash photo and the metadata indicates there was no flash used, chances are the photograph is a fake. Hence, the metadata may provide the “forensic clues” to assist the user in verifying the authenticity of the captured image.

By coupling the design of the digital camera with the viewer and encryption modules on a host system, a manufacturer may provide a secure digital photography system that is capable of protecting the integrity of an image from the time it is captured, to display and distribution of the image. The manufacturer may thus be able to promote a trusted brand of cameras associated with secure digital photography.

Further enhancements to the security of the system described above may be added. In one embodiment, the user's computer system 30 interacts with a website 50 of a camera manufacturer, camera distributor, or other entity accessible by server computer system 52. The server computer system may be accessible over the Internet 54, an intranet, or other network. Since the date setting of most known digital cameras may be changed freely by the user, in one embodiment of the present invention, the camera user may be required to access the camera manufacturer's or distributor's website (with the camera coupled to the user's computer system). Interaction with the website may cause the download of a secure date and time stamp to the computer system and thence on to the camera. The secure date and time stamp may be encrypted using a private key as described above. This may deter users from changing the date and time in an attempt to affect the authenticity of metadata generated by the camera.

In another embodiment, when the camera manufacturer's or distributor's website is accessed by the camera user, one or more new private keys may be downloaded from the web site through the computer system and into the camera. Additionally, new encryption algorithms may also be downloaded. Either of these two steps may be required on a periodic basis. For example, software resident in the decryption and/or viewer modules may be pre-set by the manufacturer to operate for a predetermined period of time (e.g., 30 days, 60 days, or 90 days, and so on). At the end of the time period, the camera user may be required to “log on” to the manufacturer's or distributor's website to obtain new keys and/or security software for downloading to the camera and/or the camera user's computer system for the next time period. The relationship required between the camera owner/user and the camera manufacturer or distributor for secure interaction via the manufacturer's or distributor's website may be set up when the camera is purchased or soon thereafter.

In other embodiments, further sensors may be added to the digital camera to provide additional metadata components. In one embodiment, a thermometer may be included to obtain the temperature of the site where the photo is taken. The temperature at the time of image capture may be stored in the metadata. Similarly, a barometer may be included in the digital camera to obtain the barometric pressure reading at the time of image capture. This also may be stored in the metadata. In another embodiment, a compass may be included in the digital camera to record the orientation of the camera at the time of image capture. The compass reading may also be stored in the metadata. In yet another embodiment, a fingerprint reading device known in the art may be included in the camera, to record the fingerprint data of the photographer at the time of image capture. The fingerprint data may be stored in the metadata.

In one embodiment, audit data 28 may be used to add an additional level of authentication. The audit data may store information relating to any changes made to the image data since the image was captured by the camera. For example, adjustments to the colors of the image, cropping of the image, manipulation of pixel data, and so on, may be recorded in the audit data. When the image is viewed by the viewer module, the viewer module may be used to reconstruct the original image according to the imaging operations applied to the image since it was captured. The metadata may be displayed along with the image data to show a user the characteristics of the image. Additionally, the audit data may also be displayed to show the user a history of alterations to the image. By using viewer module 42 or other photo editor tool that is tamper-resistant, one can gain additional assurance that only those changes to the image listed in the audit data have been made, and that the viewer module or other tool has not been “hacked.”

The secure digital photography system of the present invention thus provides at least three levels of security. First, any image contained in a file read by the viewer module must be captured by a digital camera closely coupled with the system. In essence, only certain digital cameras associated with the system are allowed to create authentic photograph files. The digital camera and the host modules are integrated. Second, the characteristics of the captured image are stored as metadata along with the image data. The metadata provides evidence of when, where, and how the image was captured. The characteristics may also include audit data tracking image changes. Third, the image data and the metadata are encrypted inside the camera, making it difficult to fake a photograph, or to alter or manipulate the image once it has been captured without detection.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features were omitted or simplified in order not to obscure the present invention.

Embodiments of the present invention may be implemented in hardware or software, or a combination of both. Some embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A digital camera comprising:
a memory to store image data of a captured image representing a scene in the physical world; and
an encryption module configured to digitally sign the image data prior to storage using a private key of an asymmetric key pair.

2. The digital camera of claim 1, wherein the encryption module is configured to obtain metadata associated with the image data and to digitally sign the image data and the metadata.

3. The digital camera of claim 1, wherein the metadata comprises at least one of date and time the image was captured, at least one of name and identifier of the camera owner, at least one of name and identifier of the photographer, focal distance, white levels, f-stop, brightness compensation, and distance for auto-focus, and digital signature of the image data, when the image was captured.

4. The digital camera of claim 1, further comprising a global positioning system (GPS) detector configured to determine a geographic location of the digital camera and wherein the metadata comprises the geographic location of the camera when the image was captured.

5. The digital camera of claim 1, wherein the private key is uniquely associated with the digital camera.

6. The digital camera of claim 1, wherein the private key is uniquely associated with a manufacturer of the digital camera.

7. The digital camera of claim 1, wherein the private key is uniquely associated with an owner of the digital camera.

8. The digital camera of claim 1, wherein the encryption module is tamper-resistant.

9. A digital photography subsystem comprising:
a decryption module to accept image data and metadata from a digital camera, the metadata including a digital signature of the image data, and to verify the digital signature of the image data to determine authenticity of an image represented by the image data; and
a viewer module to display the image data when the decryption module indicates the image data is authentic.

10. The digital photography subsystem of claim 9, wherein the decryption module is further configured to examine the metadata to determine authenticity of the image data.

11. The digital photography subsystem of claim 10, wherein the metadata comprises at least one of date and time the image was captured, at least one of name and identifier of the camera owner, at least one of name and identifier of the photographer, focal distance, white levels, f-stop, brightness compensation, and distance for auto-focus, when the image was captured.

12. The digital photography subsystem of claim 11, wherein the metadata comprises a geographic location of the digital camera when the image was captured and the decryption module is configured to examine the geographic location when determining authenticity of the image.

13. The digital photography subsystem of claim 11, wherein the viewer module is configured to display the metadata in addition to the image data.

14. The digital photography subsystem of claim 11, wherein the image data and metadata is associated with audit data indicating changes to the image data, and the viewer module is configured to display the audit data.

15. A secure digital photography system comprising:
a digital camera including a memory to store image data of a captured image representing a scene in the physical world, and an encryption module configured to digitally sign the image data prior to storage using a private key of an asymmetric key pair and to obtain metadata associated with the image data, the metadata including the digital signature of the image data; and
a digital photography subsystem including a decryption module to accept image data and metadata from the digital camera and to verify the digital signature of the image data to determine authenticity of the captured image represented by the image data using a public key of the asymmetric key pair, and a viewer module to display the image data when the decryption module indicates the image data is authentic.

16. The secure digital photography system of claim 15, wherein the metadata comprises at least one of: date and time the image was captured, at least one of name and identifier of the camera owner, at least one of name and identifier of the photographer, focal distance, white levels, f-stop, brightness compensation, and distance for auto-focus, and digital signature of the image data, when the image was captured.

17. The secure digital photography system of claim 16, wherein the digital camera further comprises a global positioning system (GPS) detector configured to determine geographic location of the digital camera and wherein the metadata comprises the geographic location of the camera when the image was captured.

18. The secure digital photography system of claim 16, wherein the decryption module is further configured to examine the metadata to determine authenticity of the image data.

19. A method of generating photograph data comprising:
capturing image data representing an image in the physical world by a digital camera;
obtaining metadata associated with the captured image;
digitally signing the image data with a private key of an asymmetric key pair; and
storing the image data and metadata in a memory of the digital camera.

20. The method of claim 19, wherein the metadata comprises at least one of date and time the image was captured, at least one of name and identifier of the camera owner, at least one of name and identifier of the photographer, focal distance, white levels, f-stop, brightness compensation, and distance for auto-focus, and digital signature of the image data, when the image was captured.

21. The method of claim 20, further comprising digitally signing the metadata prior to storage.

22. The method of claim 20, further comprising determining a geographic location of the digital camera and wherein the metadata comprises the geographic location of the camera when the image was captured.

23. The method of claim 19, wherein the private key is uniquely associated with the digital camera.

24. The method of claim 19, wherein the private key is uniquely associated with a manufacturer of the digital camera.

25. The method of claim 19, wherein the private key is uniquely associated with an owner of the digital camera.

26. A method of generating and authenticating digital photographs comprising:
capturing image data representing an image in the physical world by a digital camera;
obtaining metadata associated with the captured image, the metadata indicating characteristics of the image data;
digitally signing the image data with a private key of an asymmetric key pair; and
transferring the image data, the digital signature, and the metadata to a host system;
authenticating the image data by the host system using the digital signature, a corresponding public key of the asymmetric key pair, and the metadata.

27. The method of claim 26, wherein the metadata comprises at least one of date and time the image was captured by the digital camera, at least one of name and identifier of the camera owner, at least one of name and identifier of the photographer, focal distance, white levels, f-stop, brightness compensation, and distance for auto-focus, when the image was captured.

28. The method of claim 27, further comprising obtaining the date and time setting for the digital camera by the host system from a website controlled by at least one of the manufacturer and the distributor of the digital camera.

29. The method of claim 26, further comprising updating the private key for the digital camera by the host system from a website controlled by at least one of the manufacturer and the distributor of the digital camera.

30. The method of claim 27, further comprising determining a geographic location of the digital camera when capturing the image and wherein the metadata comprises the geographic location of the camera when the image was captured.

31. The method of claim 26, further comprising displaying the image data when authenticated.

32. The method of claim 26, further comprising updating audit data describing changes made to the image data, and associating the audit data with the image data and the metadata.
